(19) United States
(12) Patent Application Publication
(10) Pub. No.: US 2019/0303819 A1
(43) Pub. Date: Oct. 3, 2019

(54) SYSTEMS, METHODS AND APPARATUS FOR WORKFLOW OPTIMIZATION FOR USE IN MANUFACTURING, STORAGE AND OTHER APPLICATIONS

(71) Applicant: PORTABLE INTELLIGENCE INC., Markham (CA)

(72) Inventor: JEFF LEM, Markham (CA)

(73) Assignee: PORTABLE INTELLIGENCE INC., Markham (CA)

(21) Appl. No.: 16/374,319

(22) Filed: Apr. 3, 2019

Related U.S. Application Data
(60) Provisional application No. 62/651,971, filed on Apr. 3, 2018.

(51) Int. Cl. G06Q 10/06; G06Q 10/08

(52) U.S. Cl. CPC G06Q 10/0633; G06Q 10/063116; G06Q 10/08; G06Q 10/06313; G06Q 10/06312

(57) ABSTRACT

The present invention relates to systems, methods and apparatus for workflow optimization for use in manufacturing, warehousing storage and other applications. The present invention is directed to a task engine distributor which provides a simple yet effective systems, methods and apparatus for monitoring output of the warehousing operations (including manufactories facilities, distribution centres, etc.), scheduling work and the underlying tasks within the warehouse optimizing the use of personnel and material within the warehouse operation; re-allocating tasks dynamically within the warehouse operation; reviewing and updating task related benchmarks; and taking and giving feedback and encouragement to personnel.

### CROSS REFERENCE TO RELATED APPLICATION

This application claims the benefit of U.S. Provisional Application No. 62/651,971, filed on Apr. 3, 2018. The entire disclosure of the above application is incorporated herein by reference.

### FIELD

The present invention relates to systems, methods and apparatus for workflow optimization for use in manufacturing, warehousing storage and other applications. The present invention is directed to a task engine distributor which provides a simple yet effective systems, methods and apparatus for monitoring output of the warehousing operations (including manufacturing, distribution facilities, etc.), scheduling work and the underlying tasks within the warehousing operation, optimizing the use of personnel and material within the warehousing operation, re-allocating tasks dynamically within the warehousing operation, reviewing and updating task related benchmarks, and taking and giving feedback, analytics, and encouragement to personnel.

### BACKGROUND

In inventory management operations, such as for example, warehousing and factory operations, there is a desire to maintain complete, accurate and up to date records and workflows of the products made, stored, received, processed, shipped and/or sold as well as personnel available. Automated or automatic methods of providing such records are desirable, however, conventional methods all have shortcomings that result in less than the desired record being provided. Various schemes for creating and executing a workflow process have been proposed.

For example, Manufacturing systems brought to North America from Asian countries also have imbedded in their processes certain assumptions about the workforce which dictates the systems of control and monitoring of work flow. In Asian cultures, workers are inclined to be more disciplined and compliant with company rules and regulations as result the manufacturing systems which purport to monitor work is minimal or non-existent and more focussed around tracking production output not task output. These manufacturing systems brought to North America often face a difficult implementation period with a workforce culture that is more inclined to be independent, self-sufficient, and idealistic. Attempts to monitor North American workers fail to significantly improve productivity as its implemented by managers who come from a culture that didn't have to monitor and control workers to the extent needed here. In fact most attempts using conventional techniques such as timesheets or scanning location barcodes to control and monitor warehouse workers fail as workers find system loopholes and/or workarounds.

As yet another example, U.S. published patent application number 2002/0095311 to the present inventor describes a technique for facilitating a business process involving negotiation of a contract. In one variation of that technique, two negotiators are provided with structured steps for negotiating a contract, and are permitted to defer agreement on certain aspects of the contract until a later phase of the negotiation process.

The creation of a workflow process to carry out a business process usually begins by defining steps and parameters of that process, followed by development of customized computer software to execute the process. Such a creation method may be difficult or unwieldy for a novice user. It may be cumbersome to think abstractly about steps that should be executed and the order in which they must be executed. Moreover, the creation of custom-made software is expensive and time-consuming.

Communication between computers, portable electronic devices and other forms of interne of things (IoT) devices, etc. has become an important aspect of maintaining these records as well as, everyday life in private, industrial, and business environments. Data networks provide a medium for such communication and further for communication between various types of devices connected to the network such as servers, personal computers, workstations, IoT devices, memory storage systems, or any other component capable of receiving or transmitting data to or from the network.

Much of the prior art describes the use of RFID tags to track product, ensuring proper storage, handling appropriately (not placed in a theft bag), track its movement and/or location.

The workflows taught by the prior art do not take into situational and/or environmental changes with regard to the object or objective, such as routing and environmental changes, the arrival or non-arrival of a delivery truck or a new overriding priority such as an emergency order, that may change the timing and structure of the task associated with the object or objective. The creation of actionable awareness is not disclosed in the prior art.

There remains a need for systems and method, for an automated workflows that can adjust based on situational awareness.

### SUMMARY

Accordingly, it is an object of this invention to at least partially overcome some of the disadvantages of the prior art.

An aspect of the present invention is directed to a system for managing tasks during the operation of a warehouse, the system comprising: (a) setting at least one initial parameter for the operation of the warehouse; (b) setting at least one priority during the operation of the warehouse; (c) commencing and monitoring the actual operation of the warehouse; (d) comparing the actual operation of the warehouse compared with the at least one priority and the at least one initial parameter to determine whether the operation of the warehouse is considered on track or off track; and (e) taking remedial steps based on the comparison from step (d).

Another aspect of the present invention is directed to the previous system wherein step (a) further comprises a scheduled timeline to complete at least one priority based on labour and materials.

Another aspect of the present invention is directed to the previous system wherein step (e) further comprises identifying one or more workers to whom work should be assigned.

Another aspect of the present invention is directed to the previous system wherein the setting step (a) comprises at least one pick option.

Another aspect of the present invention is directed to the previous system wherein the pick option is selected from the group consisting of Pickfaces Only, FIFO or LIFO, Fast Pick, Stable Pallet, Minimize Honeycomb, Minimize Travel, and Output Level. Another aspect of the present invention is directed to the wherein operation options may include Pallet Cube Size, Serpentine Y/N, Labour Units, Standby Labor, Hrs per Shift and other production benchmarks.

### DRAWINGS

In the drawings, which illustrate embodiments of the invention:

FIG. 1 provides a preferred embodiment of the present invention.

FIG. 2 provides a preferred embodiment of the present invention.

FIG. 3 provides a preferred embodiment of the present invention.

FIG. 4 provides a preferred embodiment of the present invention.

### DETAILED DESCRIPTION

The description that follows, and the embodiments described therein, is provided by way of illustration of an example, or examples, of particular embodiments of the principles and aspects of the present invention. These examples are provided for the purposes of explanation, and not of limitation, of those principles and of the invention.

It should also be appreciated that the present invention can be implemented in numerous ways, including as a process, method, an apparatus, a system, a device or a method. In this specification, these implementations, or any other form that the invention may take, may be referred to as processes. In general, the order of the steps of the disclosed processes may be altered within the scope of the invention. The description that follows, and the embodiments described therein, is provided by way of illustration of an example, or examples, of particular embodiments of the principles and aspects of the present invention. These examples are provided for the purposes of explanation, and not of limitation, of those principles and of the invention.

It will be understood by a person skilled in the relevant art that in different geographical regions and jurisdictions these terms and definitions used herein may be given different names, but relate to the same respective systems.

A person skilled in the relevant art would understand that the term “engine” to refer to a software program that performs a core or essential function for other programs. Engines may be used in operating systems, subsystems or application programs to coordinate the overall operation of other programs.

A person skilled in the art will understand the terms “workflow process” or “executing a workflow process” refer to executing steps of a business process using software tools including engines. For example, U.S. Pat. No. 6,571,246 describes a method for managing a workflow using the Internet. As another example, U.S. Pat. No. 6,505,176 describes a system for automatically coordinating workflow among various workgroups in a credit application process. Workflow systems according to the present invention monitor data, such as definition of the workflow, status of operation of the workflow, status of an organization, schedule of individual and so forth, perform operation of optimal workflow operation, and predict or expect occurrence of problem, such as expiration of deadline, in advance by providing a workflow predicting and evaluating means predicting future progress.

A person skilled in the relevant art would understand the term “wearable” to refer to wearable technology is a blanket term for electronics that can be worn on the body, either as an accessory or as part of material used in clothing. There are many types of wearable technology but some of the most popular devices are activity trackers and smartwatches. One of the major features of wearable technology is its ability to connect to the internet, enabling data to be exchanged between a network and the device. This ability to both send and receive data has pushed wearable technology to the forefront of the Internet of Things (IoT).

A person skilled in the relevant art would understand the term “smart warehouse” to refer to a warehouse utilizing connective and connection technology to form a “hub”, engine or task engine to boost efficiency and speed throughout the entire supply chain. From wearables on workers to sensors and smart equipment, internet-enabled devices and technology can be used to create, alter, modify or change logistics management.

A person skilled in the relevant art would understand the term “augmented reality” as technology using images and animation to guide and support each task (e.g. pallet building and turn by turn directions), provide text and voice instructions, capture video and images, provide feedback and positive reinforcement.

As those of ordinary skill in the art would understand, the Internet is a global data network which comprises a vast number of computers, devices and data networks which are interconnected through communication links. A person skilled in the relevant art will understand that an electronic communications network of the present invention, may include, but is not limited to, one or more of the following: a local area network (LAN), a wide area network (WAN), an intranet, or the Internet (e.g. the Web, World Wide Web, etc.). The interconnected devices exchange information using various services, including, but not limited to, electronic mail, Gopher, web-services, application programming interface (API), File Transfer Protocol (FTP) In an example, a network allows a server computer system (a Web server) to send graphical Web pages of information to a remote client computer system. The remote client computer system can then display the Web pages via its web browser. Each Web page (or link) of the WWW is uniquely identifiable by a Uniform Resource Locator (URL). To view a specific Web page, a client computer system specifies the URL for that Web page in a request (e.g., a HyperText Transfer Protocol (“HTTP”) request). The request is forwarded to the Web server that supports the Web page. When the Web server receives the request, it sends the Web page to the client computer system. When the client computer system receives the Web page, it typically displays the Web page using a browser. A web browser or a browser is a special-purpose application program that effects the requesting of web pages and the displaying of web pages and the use of web-based applications. Commercially available browsers include Microsoft Internet Explorer and Firefox, Google Chrome among others. It will be understood that with embodiments of the present invention, any browser would be suitable.

Web pages are typically defined using HyperText Markup Language (“HTML”). HTML provides a standard set of tags that define how a Web page is to be displayed. It will be understood that other languages, all well known in the art, may be used with the embodiment of the present invention. When a user indicates to the browser to display a Web page, the browser sends a request to the server computer system to transfer to the client computer system an HTML or other language document that defines the Web page. When the requested HTML document is received by the client computer system, the browser displays the Web page as defined by the HTML document. The HTML or other language document contains various tags that control the displaying of text, graphics, controls, and other features. The HTML document may contain URLs of other Web pages available on that server computer system or other server computer systems.

Elements of the present invention may be implemented with devices that are well known in the art. A person skilled in the art will understand the term “device” to refer any networked, network ready or capable of being networked device, including but not limited to computers, mobile devices, portable devices, wearables switches, IoT devices, and software applications. Generally speaking, devices such as computers include a central processor, system memory, and a system bus that couples various system components (typically provided on cards, including the system memory, to the central processor. A system bus may be any of several types of bus structures including a memory bus or memory controller, a peripheral bus, and a local bus using any of a variety of bus architectures. The structure of a system memory may be well known to those skilled in the art and may include a basic input/output system (BIOS) stored in a read only memory (ROM) and one or more program modules such as operating systems, application programs and program data stored in random access memory (RAM). Computers may also include a variety of interface units and drives for reading and writing data. A user or member can interact with computer with a variety of input devices, all of which are known to a person skilled in the relevant art. Computers can operate in a networked environment using logical connections to one or more remote computers or other devices, such as a server, a router, a network personal computer, a peer device or other common network node, a wireless telephone or wireless personal digital assistant. The computer of the present invention may include a network interface that couples the system bus to a local area network (LAN). Networking environments are commonplace in offices, enterprise-wide computer networks and home computer systems. A wide area network (WAN), such as the Internet, can also be accessed by the device. Devices can operate in a networked environment using logical connections to one or more remote computers or other devices, such as a server, a router, a network computer or mobile device, a peer device or other common network node, a wireless telephone or wireless personal digital assistant. The devices of the present invention may include a network interface that couples the system bus to a local area network (LAN). Networking environments are commonplace in offices, enterprise-wide computer networks and home computer systems.

Although the present specification describes components and functions implemented in the embodiments with reference to standards and protocols known to a person skilled in the art, the present disclosure as well as the embodiments of the present invention are not limited to any specific standard or protocol. Each of the standards for Internet and other forms of network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

Preferred embodiments of the present invention can be implemented in numerous configurations depending on implementation choices based upon the principles described herein. Various specific aspects are disclosed, which are illustrative embodiments not to be construed as limiting the scope of the disclosure. Although the present specification describes components and functions implemented in the embodiments with reference to standards and protocols known to a person skilled in the art, the present disclosures as well as the embodiments of the present invention are not limited to any specific standard or protocol.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. may be set out, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system or a networked environment. It has proven convenient at times, principally for reasons of common usage, to refer to these signals as bits, values, elements, symbols, characters, terms, numbers or the like.

A person skilled in the relevant art will understand a web-based application refers to any program that is accessed over a network connection using HTTP, rather than existing within a device's memory. Web-based applications often run inside a web browser or web portal. Web-based applications also may be client-based, where a small part of the program is downloaded to a user's desktop, but processing is done over the Internet on an external server. Web-based applications may also be dedicated programs installed on an internet-ready device, such as a smart phone.

In the following specification, it will be understood by a person skilled in the relevant art that the term “user” refers to a person who or a software application that makes use of the workflows of the present invention and the term “user” shall refer to a user of the system recited herein. In some cases, the user is a member of a group (e.g. employee, contractor, etc.) with known access privileges as part of that membership.

It will be understood by a person skilled in the relevant art that the term “mobile device” or “portable device” refers to any portable electronic device on wearables that can be used to access a computer network such as, for example, the Internet (e.g. A network ready device). Typically a portable electronic device comprises a display screen, at least one input/output device, a processor, memory, a power module and a tactile man-machine interface as well as other components that are common to portable electronic devices individuals or members carry with them on a daily basis. Examples of portable devices suitable for use with the present invention include, but are not limited to, smart phones, cell phones, wearables, wireless data/email devices, tablets, PDAs and MP3 players.

It will be understood by a person skilled in the relevant art that the term “network ready device” or “internet ready device” refers to devices that are capable of connecting to and accessing a data network, such as, for example, the internet. A network ready device may assess the computer network through well-known methods, including, for example, a web-browser. Examples of interne-ready devices include, but are not limited to, mobile devices (including smart-phones, tables, PDAs, etc.), gaming consoles, and smart-TVs. It will be understood by a person skilled in the relevant art that embodiment of the present invention may be expanded to include applications for use on a network ready device (e.g. cellphone). In a preferred embodiment, the network ready device version of the software application may have a similar look and feel as a browser version but that is optimized to the device.

It will be further understood by a person skilled in the relevant art that the term “downloading” refers to receiving datum or data to a local system (e.g. mobile device, work station, laptop, etc.) from a remote system or to initiate such a datum or data transfer. Examples of a remote systems or clients from which a download might be performed include, but are not limited to, web servers, FTP servers, email servers, or other similar systems. A download can mean either any file that is offered for downloading or that has been downloaded, or the process of receiving such a file. A person skilled in the relevant art will understand the inverse operation, namely sending of data from a local system (e.g. mobile device) to a remote system is referred to as “uploading”.

One skilled in the relevant art would appreciate that the device connections mentioned herein are for illustration purposes only and that any number of possible configurations and selection of peripheral devices could be coupled to the computer system.

It will be appreciated that the type of connections contemplated herein are exemplary and other ways of establishing a communications link between devices. The existence of any of various well-known protocols, such as TCP/IP, Frame Relay, Ethernet, FTP, HTTP and the like, is presumed, and computer can be operated in a client-server configuration to permit a user to retrieve and send data to and from a web-based server. Furthermore, any of various conventional web browsers can be used to display and manipulate data in association with a web based application.

The operation of the network ready device (e.g. mobile device, computer, work station, etc.) may be controlled by a variety of different program modules. Examples of program modules are routines, programs, objects, components, data structures, etc. that perform particular tasks or implement particular abstract data types. It will be understood that the present invention may also be practiced with other computer system configurations, including multiprocessor systems, microprocessor-based or programmable consumer electronics, network PCS, minicomputers, mainframe computers, and the like. Furthermore, the invention may also be practiced in distributed computing environments where tasks are performed by remote processing devices that are linked through a communications network. In a distributed computing environment, program modules may be located in both local and remote memory storage devices.

Embodiments of the present invention can be implemented by a software program for processing data through one or more devices (e.g. computer system). It will be understood by a person skilled in the relevant art that the computer system can be any device (e.g. personal computer, mobile device, notebook computer, server computer, mainframe, networked computer (e.g., router), workstation, software application and the like). The program or its corresponding hardware implementation is operable for providing user authentication and authorization. In one embodiment, the computer system includes a processor coupled to a bus and memory storage coupled to the bus. The memory storage can be volatile or non-volatile (i.e. transitory or non-transitory) and can include removable storage media. The computer can also include a display, provision for data input and output, etc. as will be understood by a person skilled in the relevant art.

It will be understood that in establishing a user interface, a task bar may be preferably positioned at the top of a screen to provide a user interface. Preferably, a textual representation of a task's name is presented in this user interface, preferably as a button, and the task names may be shortened as necessary if display space of the button is constrained. The labelled button having the task's name preferably operate as a type of hyperlink, whereby the user/viewer can immediately switch to the activity, view, etc. of an each of the tasks by selecting the button containing the applicable name from the task bar. In other words, the user or viewer is redirected by the application to that the function represented by the task button by selecting the labelled hyperlink. Preferably, the task entry associated with the currently-displayed work unit view may be shown in a different graphical representation (e.g., using a different color, font, or highlighting). In preferred embodiments, there may be provided a display having a selectable “X” in the task bar entry for each task: if the user clicks on the “X”, then its associated task may be ended and the view of its work unit may be removed. A user interface may be web-based, application based, or a combination.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “creating,” “providing,” or the like refer to the actions and processes of a computer system, or similar device, including an embedded system, that manipulates and transfers data represented as physical (electronic) quantities within the computer system's registers and memories into other data similarly represented as physical quantities within the computer system memories or registers or other such information storage, transmission or display devices.

The prior art may suggest some form of “context” intelligence or “awareness component” which is constantly taking into situational changes of the ‘seen object’ or item with the attached RFID tag, making notes in its routing and environmental changes. Embodiments of the present invention provide a “task engine distributor” (“TED”), which is an intelligence engine dynamically reallocating work tasks based on past, present or future properties, such as worker profile (certification, skill level, equipment, current activity), their location in the facility, and changing priorities that happen over the course of an assigned task or day.

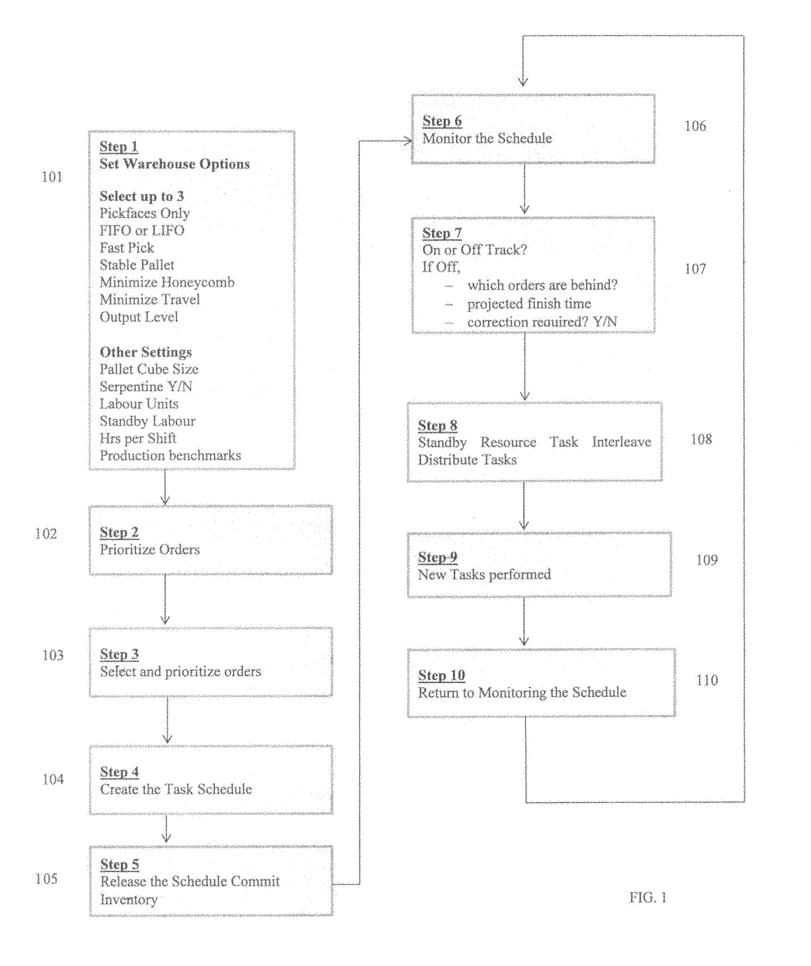

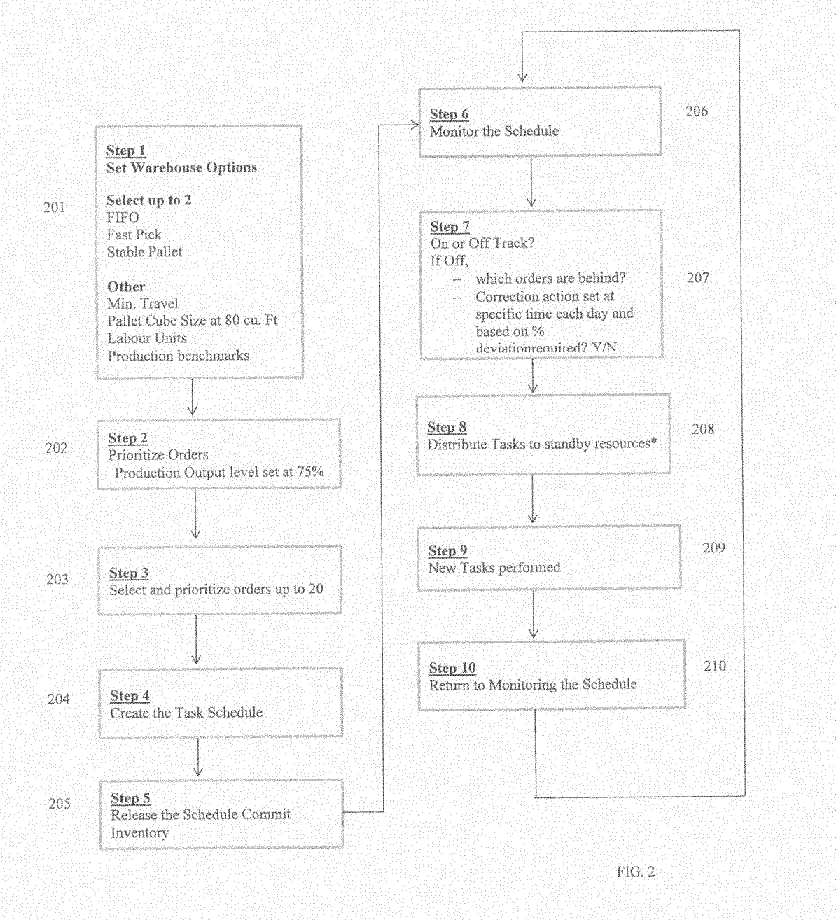

The workflows provided in FIGS. 1 and 2 provide preferred embodiments of the present invention. FIG. 1 provides a workflow where up to three tasks or activities can be selected. It will be understood that the tasks or activities can consist of any well known tasks or could consist of a customized task 101. For example, at the beginning of the shift the focus may be to start all high priority work tasks based on warehouse and supply chain practices such as maximizing inventory turns, building stable pallets, maximizing cubic yield out of each pallet, doing fast pick processes, or picking to optimize warehouse capacity. As provided in 102, the orders required to complete the task are prioritized and then selected and a task schedule is created (103 and 104). Once underway as provided in 105, the process is monitored in 106, assessed in 107 and remedial action 108 and 109 can be taken. The monitoring in 106 then continues as set out in 110. FIG. 2 shows preferred embodiment whereas the impact on a specific goal of production output levels of 75%.

As the day nears the end, customer and logistical priorities take over: orders for specific customers or for delivery trucks that have actually arrived will take precedence and those orders will be moved up in priority along with the associated tasks. Likewise, if the order volume is slow that day priorities may be around inventory turns and reducing the number of ‘honeycombed’ warehouse slots. A personal skilled in the relevant art will understand “honeycomb” to refer to the tendency of warehouse bin locations or slots to start looking like a honeycomb over time which there is too many partially filled bin locations.

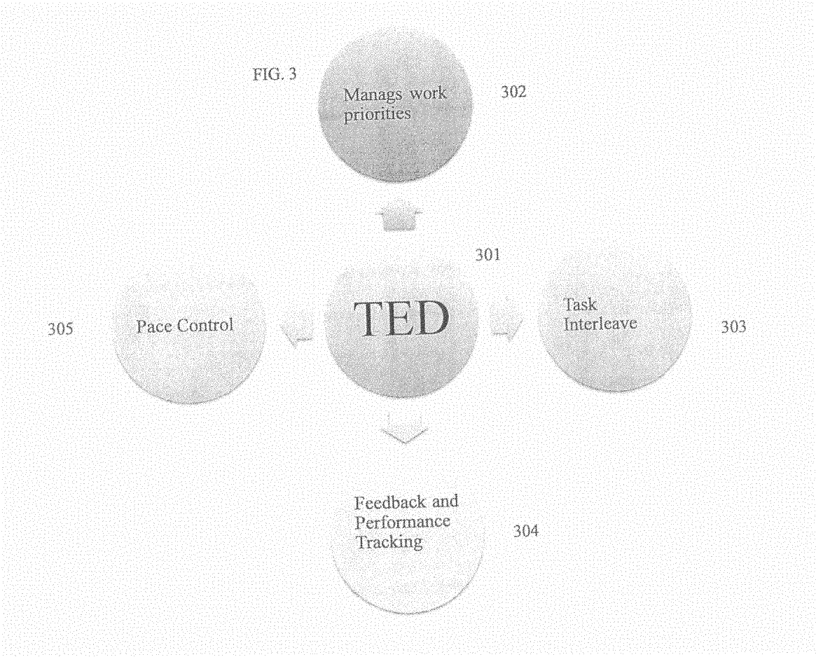

As shown in FIG. 3, there is provided a representation of how TED handles the work flow process. As shown in FIG. 3, there is provided TED 301 which interacts with and can modify work priorities 302, task interleaving 303, feedback and performance tracking 304 and pace control 305. It will be understood that task interleaving 303 refers to the productivity practice to reduce idle or indirect labor hours (e.g. when a worker, for example, picks products and drops them off at a dock and then returns to the picking area without performing a task in the dock area. In this example, TED could instruct the worker to perform a cross dock activity or even perform a direct to line replenishment whereby high demand product is taken immediately to the production area to prevent line shut down). The TED system of the present invention, as shown in FIG. 3 provides for monitoring output and priorities, schedules work and the underlying tasks which leads to optimizes labor, dynamically re-allocating tasks, reviewing and updating benchmarks, incorporates and uses feedback and encouragement to personnel. TED may make use of indoor positioning technologies to determine if the task allocation is appropriate. In the earlier example, TED will not instruct a worker to perform a put-away function unless he is in close proximity to the areas where the tasks are to be performed. Conventional task interleave systems fail because they don't take into account the worker's location. While the task itself may take under a minute to perform, it is the travel distance that results in a task request being rejected. Finally, the system also allows for the management of reporting and alerts around task performance, acceptance, and rejection.

In some operations, for example, some workers may be dedicated to picking, while others may be dedicated to put-away. Task interleaving is most common in operations with workers that have permission to do both. So instead of a selector returning all the way across a warehouse to a pick zone, they may stop at a nearby receiving dock, pick up a pallet for put-away, and then store it in a location near where their next pick occurs. It will be understood that other factors involved in warehouse management systems (“WMS”) can be included in the TED decision matrix as shown in FIG. 3.

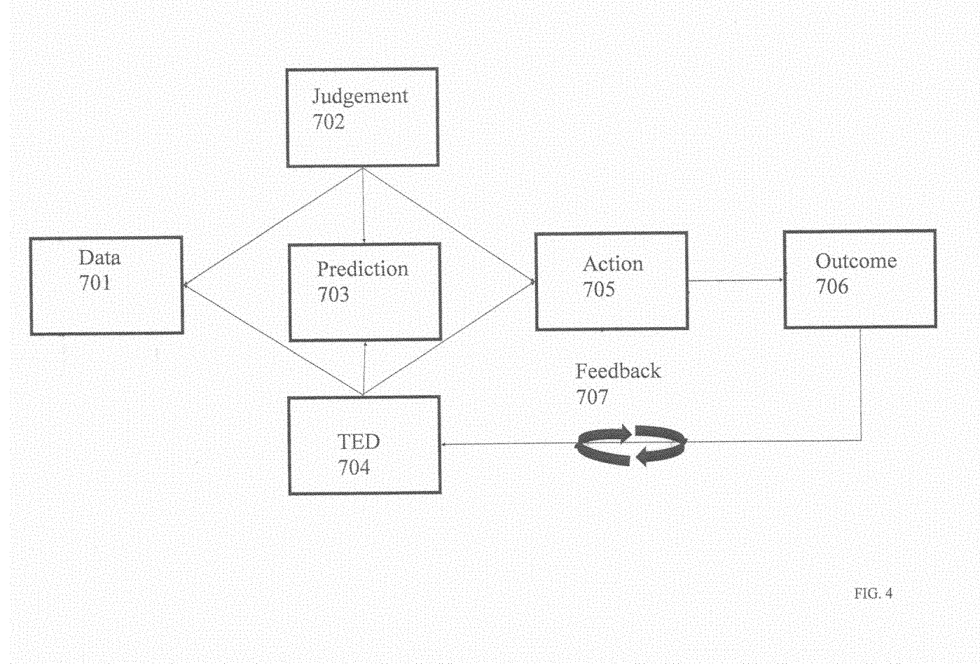

As set out in FIG. 4, there is provided an anatomy of a task. A person skilled in the relevant art will understand that a “task” is any portion of a job that serves as a means to differentiate various components of a project. A task can be broken down into assignments which should also have a defined start and end date or a deadline for completion. One or more assignments on a task puts the task under execution. Completion of all assignments on a specific task normally renders the task completed. While tasks can be scheduled individually they can also be grouped to achieve economies of scale be it servicing a particular customer and all their orders or picking all the orders associated with a certain truck route. One could also designate specific types of tasks to specific individuals for example assigning all the bulk picks to a few individuals who have both the skills and equipment to effectively pick larger volumes. In these scenarios the tasks are all linked, whose completion by a group requires the coordination and monitoring of effort. Coordinating human interaction on this level requires much by way of time, energy, effort, ability, and resources of multiple individuals to meet a common task goal. Coordination can also be thought of as the critical mechanism that links or ties together the efforts on the singular level to that of the larger task being completed by multiple members. Coordination allows for the successful completion of the otherwise larger tasks that one might encounter. As shown in FIG. 4, there is provided data 401 upon which decision(s)/judgement(s) and prediction(s) will be made or used to arrive at a specific task to be done or what will be predicted as needed to be done (see 402 and 403). Based on this, TED 404 will provide for a specific action 405, which will lead to a specific outcome 406. There will be a monitoring of the outcome so as to create feedback 407 which will then in turn feed back into TED 404. Based on the feedback, TED 404 can provide addition data 401, predictions 403 or corrective actions 405.

TED will also apply machine learning principles whereby it will perform predictive analysis over the body of work to be done - who should get which work and when to start moving around this work. Using historical volumes and prior experience, TED will be able use certain logical parameters to best achieve specific desired outcomes. Embodiments of the present invention are directed to an intelligence “engine” having a series of ‘models’ (+10 data points) used to determine a course of action or a task or make a decision within a workflow. Based on these series of ‘models’ (+10 data points), the embodiments of the present invention can learn based on those decisions, its existing knowledge base and adds the learning to its model. Consequently the systems of the present invention can be both predictive and reactive, is able to discern patterns, high frequency actions, identify key markers, and can apply regression analysis. The systems of the present invention may also learn from failure.

Embodiments of the present invention provides for “flexing” or flexible warehouse operations by changing (shifting, adding, etc.) capacity and labour. In other words, the embodiments of the present invention allow for marrying the two sets of parameters, namely warehouse operations and order priorities. The present invention provides the levers to adjust the warehouse workflow. Embodiments of the present invention provide for conducting the process described herein either automatically or with manager/supervisor supervision. There is also provided a means to manage labour as well as materials. Workers, equipped with wearable or mobile technology to send and receive, can be tasked, have the option to accept or decline the new task, and/or allocate additional workers as required. As such, the embodiments of the present invention allow the warehouse operation to dynamically “flex” within the workplace based on changes all in real time. An embodiment of the present invention creates tasks based on changing priorities in the warehouse and supply chain. The present invention does not merely track product per se, instead the present invention tracks “priorities” as initially defined in the initial environment as well as the delta between tasks done and to be done, where people are and what tasks they are performing, and if they are eligible to be re-assigned a certain task(s) (see FIG. 1 and FIG. 2). The system of the present invention can also respond to a change in the tasks assigned or in priorities, push out the new task(s), be reactive to the environment, create tasks and re-allocate tasks based on existing or future priorities. By controlling the timing and volume of tasks and priorities, virtual teams can be created “on the fly” thus allowing for more predictable output, perform pace control (advising people when they are working too slow or fast), and optimizing the labour pool—pointing them towards a certain goal of the warehouse. The embodiments of the present invention may develop one or more models involving put-away, picking, and replenishment. Put-away is the act of moving inventory after it has been duly inspected and recorded into a storage location in the warehouse. Picking is the act of selecting materials from a storage location in the warehouse that is based on a work order, customer order, transfer order, or other task list associated requiring the movement of material out of the warehouse. Replenishment is the act of moving material from typically a bulk or overstock location in the warehouse to areas where the materials will be directly issued to a manufacturing process or they are moved to a more accessible location(s) where material handling personnel will have easier and more rapid access. The replenishment process is often triggered by a location reaching a minimum acceptable quantity and includes breaking down a bulk master case quantity into smaller units of measurement such as single units or inner packs.

It will be understood that the present invention may employ “location based services” or “LBS”. A person skilled in the relevant art would understand the location based services to involve or include services to identify the location of a person or object, such as discovering the nearest cash machine (ATM) or the whereabouts of a friend or employee. LBS include parcel tracking and vehicle tracking services. It will also be understood that LBS may employ, involve or integrate with the Signify's (formerly Philips) Visible Light Communications (VLC), iBeacons, reduction and/elimination of barcode scanning, wayfinding, tracking of personnel and assets in real time, visible map of location and activity of personnel in facility, the camera and Bluetooth™ reader on smart phones.

The present invention may also identify designs and tools to build intelligence engine, identify key datapoints for the model, capture datapoints, and/or render a decision based on the foregoing.

In a preferred embodiment, TED may schedule orders and give priority to the orders (e.g. production orders or customer orders) and in turn prioritize the batch of orders. Orders can be prioritized so that one can create a schedule made in conjunction with the warehouse operations. At any point during the day the system will indicate whether the operation is behind, ahead or on track. TED creates a schedule timeline to complete all the work based on labour and materials. How well it is execute will depend on the warehouse operations. TED will review and adjust and provide action items to get back on track. TED may identify to whom should be given the work to because warehouses can be quite large and there is a need to know where people are prior to making any task allocations. TED will identify where the process are off schedule, predict what will be the likely result, and determine if an intervention is required.

TED identifies overall priorities and notes that there may be limits at each step. The requirement that there is a need to bring in more resources (e.g. labour) who has not been tasked any priority tasks and is close by. If no one is available then it will shift and present new tasks to the current labour pool a process, namely task interleaving. For example, another worker who maybe close-by working on other tasks under certain conditions be re-tasked with additional duties but not to the point of being overloaded. The embodiments of the present invention can also simulate environments so that operators can try different possible options and see if this yields better results. TED can tighten the production benchmarks in accordance with reality; can learn how things are actually getting done (e.g. how long it thinks it will take vs how long it will actually take).

Embodiments of the present invention may be integrated with Indoor Positioning Systems, iBeacons, WiFi so as to reduce and/or eliminate barcode or other types of scanning. An embodiment of the present invention may provide “wayfinding” technology (e.g. orienting items and personnel in space) (See 208 in FIG. 2). An embodiment of the present invention provides for tracking of personnel and assets in real time, including providing a map of location and activity of personnel in facility. An aspect of the present invention may use camera and Bluetooth reader on smart phones as a means for tracking the employee.

The embodiments of the present invention are not merely tracking product but priorities and changing them dynamically based on the changing environment thus optimizing labour, materials, costs, etc. Here are some examples of parameters: first in first out (“FIFO”), last in first out (“LIFO”), stable pallet (heaviest stuff at bottom), max capacities (eliminating half filled location) for maintaining capacity in the warehouse. Also need minimize travel time, minimum touches, as much inventory with minimal trips. In one embodiment of the present invention, “warehouse operations” can select any number of priorities, preferably up to 3 priorities, and then operation will manage based on those selected. FIG. 1 provides an embodiment of the present invention. In FIGS. 1 and 2, there is provided a process for utilizing TED in a warehouse environment. 101, 201 illustrate the beginning step where the initial options or parameters are established for the operation of the system. In one embodiment (101), these are selected from a number of different pick options including Pick faces Only, FIFO or LIFO, Fast Pick, Stable Pallet, Minimize Honeycomb, Minimize Travel, Output Level. Warehouse Operational options may include Pallet Cube Size, Serpentine Y/N, Labour Units, Standby Labor, Hrs per Shift and other production benchmarks.

A person skilled in the relevant art will understand that pick faces represent the most accessible levels of the warehouse typically the first and second levels of the warehouse. FIFO/LIFO are the terms first in first out and last in first out, these are picking processes used to determine the order in which you would select which products to pick first based on age. Fast Pick will direct the warehouse worker to those warehouse locations that have enough quantity to meet the desired pick quantity. Stable Pallet refers to the placement of material on a pallet in such a manner that distributes the cube volume and weight to create a balanced pallet. Minimize Honeycomb is the directed picking of materials with an emphasis on bringing the quantities in locations to zero. Minimize Travel takes into account all the required pick locations and charts a path through the warehouse that minimizes overall travel distance. Output Level will sort the pick list and direct the pickers to select the parts that have the highest demand.

A person skilled in the relevant art will understand term “warehouse operational options” to refer to settings for the warehouse that represent constraints and have a direct impact on productive capacity. Pallet Cube Size is the volume measured in cubic meters or feet of material that can be put on one pallet. Serpentine Y/N refers to the pick movement down an aisle if it is a criss-cross motion or works one side at a time. Labor Units represents the available pick personnel for that shift. Standby Labor is the available reserve labor that can be assigned tasks in the event of a potential production shortfall. Hours per shift is the available productive hours per shift for each picker.

Once these possible options have been determined, the priorities for the specific time interval are set (see 102 and 103 in FIG. 1). Following that the task schedule is created and then released and the specific operation is commenced. In 106 and 107, the scheduled activity is monitored and the determination is made whether it is considered on track or off track. Based on whether the operation is considered on track or off track, remedial steps can be taken (see 108). It is also possible that new tasks or priorities may be introduced and the system must then compensate accordingly (see 109 and 110).

Embodiment of the present invention reflect a sensitivity to both cultural and societal norms in the workplace when allocating and re-distributing tasks. Workforces often take exception to tasks being taken away from them when they are perceived to be falling behind in their tasks. This becomes highlighted when the task is given to a fellow colleague or peer who may interpret this as a form of punishment for doing their job well. Even when the tasks are re-distributed by a human manager, there may be ‘hurt’ feelings, thus the interface that manages the distribution of these tasks must be sensitive to cultural and societal norms. In this regard TED's worker interface for task management reflects an emphasis on social and team goals. Instead of individual goals, TED creates team goals. Instead of workers performing their tasks in a siloed manner, they are working together towards a common purpose. There is both praise and recognition of individual performance promoted to the group. TED may apply social media concepts to promote team unity and enhanced team performance while recognizing individual top performers.

The intelligence engine of the present invention can learn based on the process, decisions, changing environment, etc. of the present invention and adds these results to its model. It may be both Predictive and Reactive. It can support “big data” by discerning patterns, analyzing high/low output levels, identifying key parameters or markers, and performs regression analysis. It may analyze both failed and successful tasks which can be then added to its body of knowledge. Wearable technologies employing Augmented Reality may also be employed by embodiments of the present invention to include individual employees in the system that can be tracked and assigned priorities.

Although this disclosure has described and illustrated certain preferred embodiments. As shown in FIG. 1, in a second situation, of the invention, it may be to be understood that the invention may be not restricted to those particular embodiments. Rather, the invention includes all embodiments which are functional or mechanical equivalence of the specific embodiments and features that have been described and illustrated.

We claim:

1. A system for managing tasks during the operation of a warehouse, the system comprising:
(a) setting at least one initial parameter for the operation of the warehouse;
(b) setting at least one priority during the operation of the warehouse;
(c) commencing and monitoring the actual operation of the warehouse;
(d) comparing the actual operation of the warehouse compared with the at least one priority and the at least one initial parameter to determine whether the operation of the warehouse is considered on track or off track; and
(e) taking remedial steps based on the comparison from step (d).

2. The system of claim 1 wherein step (a) further comprises a scheduled timeline to complete at least one priority based on labour and materials.

3. The system of claim 2 wherein step (e) further comprises identifying one or more workers to whom work should be assigned.

4. The system of claim 1 wherein the setting step (a) comprises at least one pick option.

5. The system of claim 2 wherein the pick option is selected from the group consisting of Pickfaces Only, FIFO or LIFO, Fast Pick, Stable Pallet, Minimize Honeycomb, Minimize Travel, and Output Level.

6. The system of claim 5 wherein operation options may include Pallet Cube Size, Serpentine Y/N, Labour Units, Standby Labor, Hrs per Shift and other production benchmarks.
